(19) United States
(12) Patent Application Publication
(10) Pub. No.: US 2012/0179828 A1
(43) Pub. Date: Jul. 12, 2012

(54) SERVER APPARATUS, SESSION MANAGEMENT APPARATUS, METHOD, SYSTEM, AND RECORDING MEDIUM OF PROGRAM

(75) Inventors: Masafumi Kobayashi, Kanazawa (JP); Hiroyuki Katayama, Kawasaki (JP); Hiroshi Maeyama, Kanazawa (JP)

(73) Assignee: FUJITSU LIMITED, Kawasaki (JP)

(21) Appl. No.: 13/342,732

(22) Filed: Jan. 3, 2012

(30) Foreign Application Priority Data
Jan. 11, 2011 (JP) 2011-003330

(51) Int. Cl. G06F 15/16

(52) U.S. Cl. 709/227

(57) ABSTRACT

An apparatus includes a memory and a processor to executes a procedure, the procedure including storing, in the memory of the apparatus, identification information for identifying a session used for first access made to the server apparatus, until a certain length of time elapses from access time of the first access, obtaining the time information which indicates access time of an access made to another server apparatus, and when time information, which indicates access time of second access made to the another server apparatus after the first access by using the same session as the session used for the first access, is obtained by the obtaining until the certain length of time elapses from access time of the first access, controlling the memory to store the identification information until the certain length of time further elapses from the access time indicated by the obtained time information.

### CROSS-REFERENCE TO RELATED APPLICATIONS

This application is based upon and claims the benefit of priority of the prior Japanese Patent Application No. 2011-3330, filed on Jan. 11, 2011, the entire contents of which are incorporated herein by reference.

### FIELD

The embodiments discussed herein relate to session management.

### BACKGROUND

A single sign-on system may be used when a client terminal accesses a business server. Suppose that, when a client terminal attempts to access a business server, an authentication control system performs an authentication process and permits the access from the client terminal. In this case, the single sign-on system allows the client terminal to access the business server thereafter without performing the authentication process. In such a single sign-on system, information on the access-permitted session, namely, session information such as session identification information and access time information, is stored in the business server once the access is permitted by the authentication control system as a result of the authentication process. When the client terminal that has been permitted to access the business server attempts to access the business server thereafter, the authentication control system evaluates the session information stored in the business server and determines whether or not to perform the authentication process. When the single sign-on system includes a plurality of business servers, the session information is synchronized between the plurality of business servers. Each of the plurality of business servers determines whether or not to perform the authentication process based on evaluation of the, synchronized session information.

As techniques for synchronizing session information between a plurality of business servers, Japanese Laid-open Patent Publication No. 2006-31064 discloses the following technique. When session information is modified because one of the plurality of business servers is accessed by a client terminal after the client terminal has logged in to the plurality of business servers, the accessed business server sends the session information to the other business servers, whereby the session information is synchronized between the plurality of business servers.

In the technique described above, the business servers communicate with each other so as to synchronize the session information every time any of the business servers is accessed by the client terminal. Accordingly, the number of times communication is performed for synchronization of session information undesirably increases as the number of times the client terminal accesses the business servers increases.

### SUMMARY

According to an aspect of the invention, an apparatus includes a memory and a processor to executes a procedure, the procedure including storing, in the memory of the apparatus, identification information for identifying a session used for first access made to the server apparatus, until a certain length of time elapses from access time of the first access, obtaining the time information which indicates access time of an access made to another server apparatus, and when time information, which indicates access time of second access made to the another server apparatus after the first access by using the same session as the session used for the first access, is obtained by the obtaining until the certain length of time elapses from access time of the first access, controlling the memory to store the identification information until the certain length of time further elapses from the access time indicated by the obtained time information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a session management system according to a first embodiment.

FIG. 2 is a diagram describing a process of evaluating session information performed by an authentication control system.

FIG. 3 is a diagram describing a process of evaluating session information performed by a business server in which the session information is cached.

FIG. 4 is a block diagram illustrating a configuration of the authentication control system according to the first embodiment.

FIG. 5 is a diagram illustrating an example of a session management table stored in a repository server.

FIG. 6 is a diagram illustrating an example of a business-server management table stored in the repository server.

FIG. 7 is a block diagram illustrating a configuration of the business server according to the first embodiment.

FIG. 8 is a diagram illustrating an example of a session management table stored in the business server.

FIG. 9 is a diagram illustrating a process that is performed when a client terminal makes a request for content in the case where session information is not cached in the business server.

FIG. 10 is a diagram illustrating a process that is performed when the client terminal makes a request for content in the case where session information is cached in the business server.

FIG. 11 is a diagram describing a synchronization process of synchronizing session information.

FIG. 12 is a diagram illustrating a synchronization process of synchronizing session information between a plurality of business servers.

FIG. 13 is a timing chart describing the flow of the synchronization process.

FIG. 14 is a timing chart describing the flow of an authentication process performed in the case where the synchronization process of synchronizing session information is not performed.

FIG. 15 is a diagram describing a sign-off process.

FIG. 16 is a timing chart describing the flow of a process of managing session information performed by the individual servers.

FIG. 17 is a flowchart illustrating operations of the process performed by the business server according to the first embodiment.

FIG. 18 is a flowchart illustrating the monitoring operation of the synchronization process performed by the repository server according to the first embodiment.

FIG. 19 is a flowchart illustrating operations of the synchronization process performed by the repository server according to the first embodiment.

FIG. 20 is a diagram illustrating a hardware configuration of a computer that constitutes the individual servers.

### DESCRIPTION OF EMBODIMENTS

A session management system, a session management apparatus, a server apparatus, and a session management method according to embodiments will be described in detail below with reference to the accompanying drawings.

A configuration of a session management system according to a first embodiment, the flow of a process performed by the session management system, and advantages offered by the first embodiment will be sequentially described below.

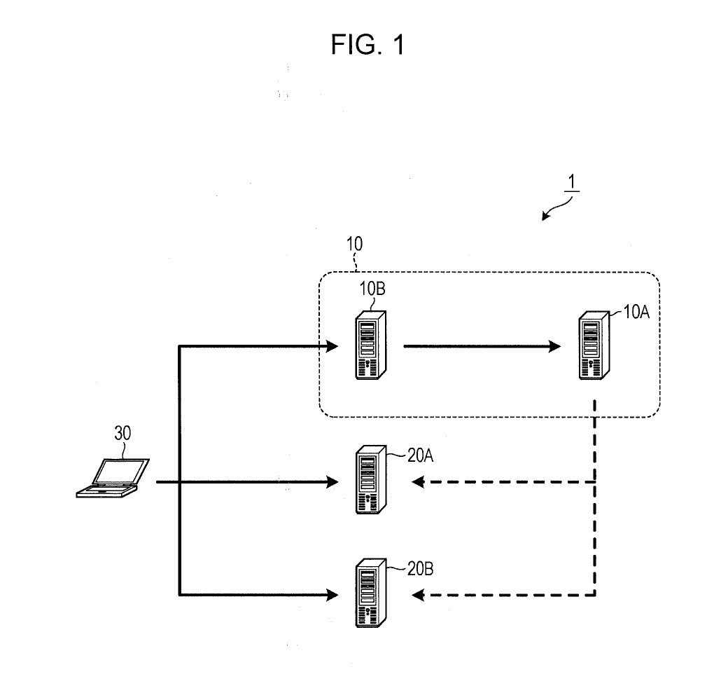

A configuration of a session management system 1 according to the first embodiment will now be described using FIG. 1. As illustrated in FIG. 1, the session management system 1 includes an authentication control system 10, a plurality of business servers 20A and 20B, and a client terminal 30.

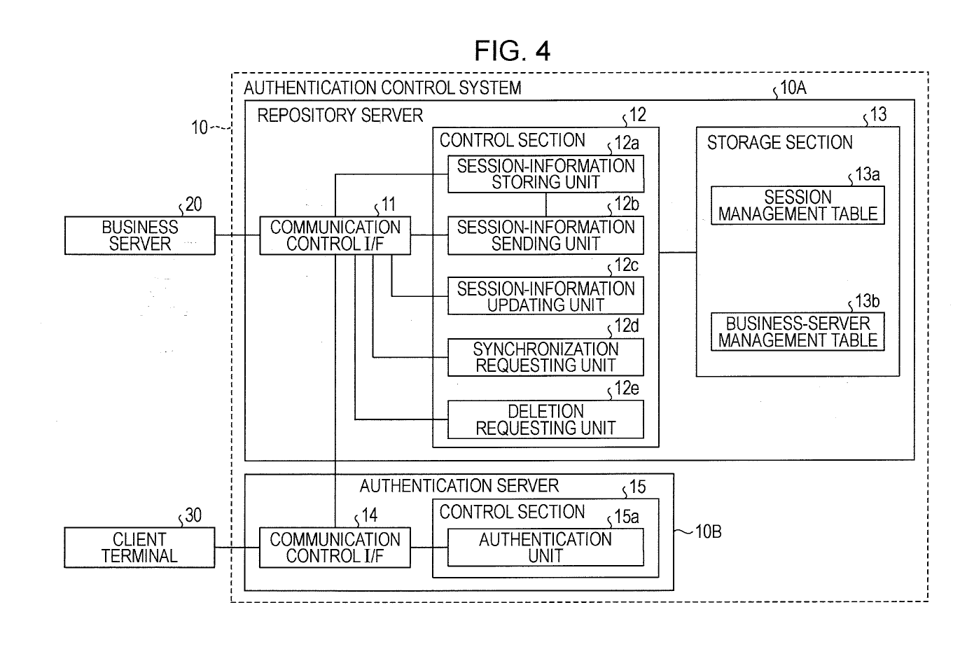

The authentication control system 10 includes a repository server 10A and an authentication server 10B. The repository server 10A manages authentication information for use in authentication and session information. The authentication server 10B receives an authentication request from the client terminal 30 and performs an authentication process. The detailed configuration and process of the authentication control system 10 will be described later using FIG. 4 and so forth.

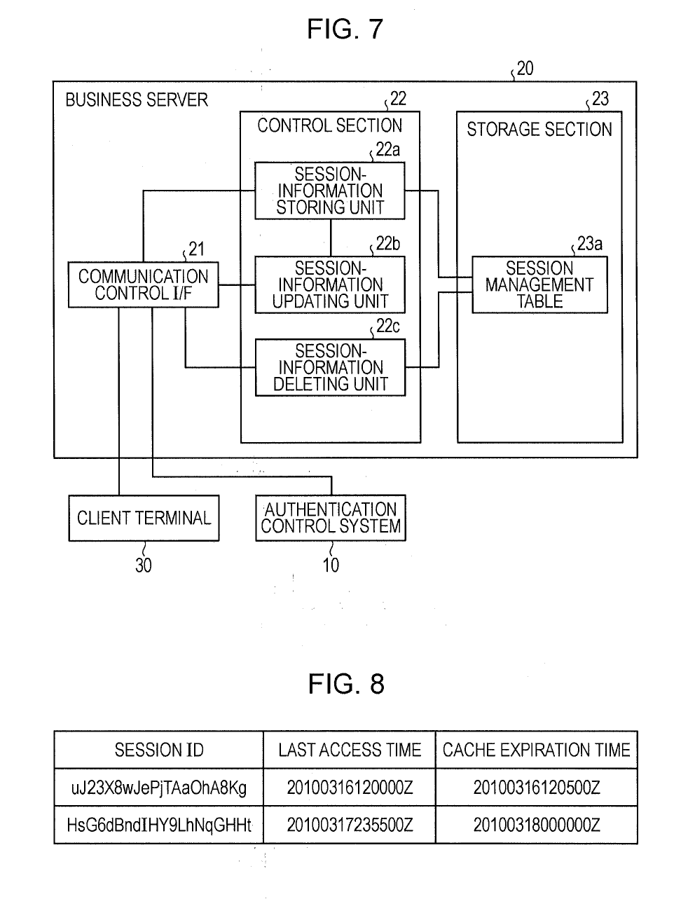

The business servers 20A and 20B receive a request for content from the client terminal 30. When session information is not cached in the business servers 20A and 20B at the time of reception of the request, the business servers 20A and 20B request the authentication control system 10 to evaluate the session information, and receives the session information from the repository server 10A. When the session information is cached in the business servers 20A and 20B at the time of reception of the request for content from the client terminal 30, the business servers 20A and 20B returns a response in accordance with the cached session information. The detailed configuration and process of the business servers 20 will be described later using FIG. 7 and so forth.

The client terminal 30 sends a request for content to the business servers 20A and 20B, and receives the content from the business servers 20A and 20B. The client terminal 30 also sends an authentication request to the authentication server 10B at the time of sign-on, and sends a sign-off request to the authentication server 10B at the time of sign-off.

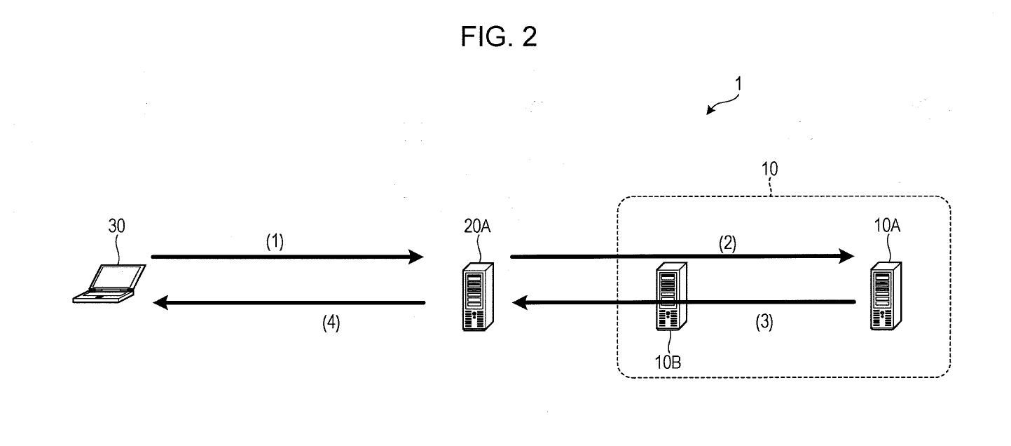

Now, a process of evaluating session information performed by the authentication control system 10 will be described concretely using an example illustrated in FIG. 2. In the example illustrated in FIG. 2, access from the client terminal 30 to the business server 20A has been permitted once, and session information regarding the access-permitted session is stored in the repository server 10A of the authentication control system 10.

As illustrated in FIG. 2, in the case where session information is not cached in the business server 20A, upon reception of a request for content sent from the client terminal 30 (see (1) in FIG. 2), the business server 20A sends an evaluation request to evaluate a session to the authentication control system 10 (see (2) in FIG. 2). Upon reception of the evaluation request from the business server 20A, the authentication control system 10 evaluates a session using the stored session information to determine whether or not to perform an authentication process. In this case, the authentication control system 10 determines that authentication process is not needed based on the session information, and sends a result of session evaluation to the business server 20A (see (3) in FIG. 2). The business server 20A receives the result of session evaluation from the authentication control system 10, and returns the content to the client terminal 30 (see (4) in FIG. 2). The evaluation request to evaluate a session and the result of session evaluation may be exchanged via the authentication server 10B.

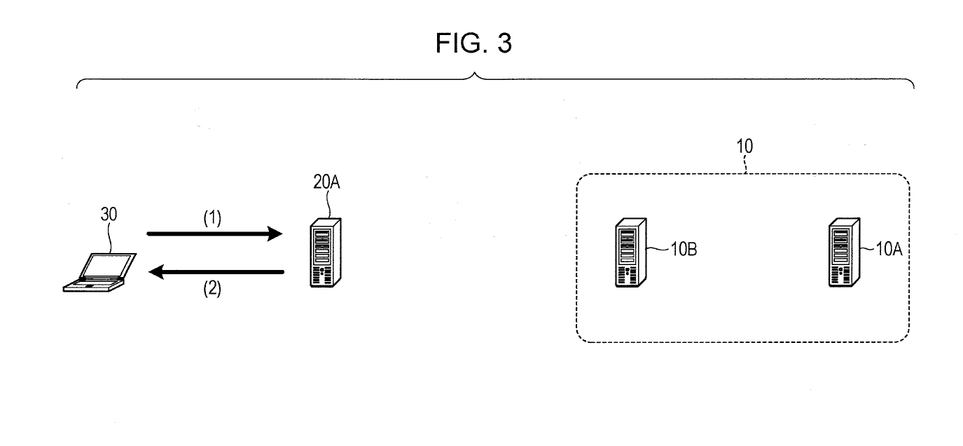

When the session information is cached in the business server 20A, the business server 20A evaluates the session information upon reception of a request for content from the client terminal 30. Now, a process of evaluating session information performed by the business server 20A will be concretely described using an example illustrated in FIG. 3. In the example illustrated in FIG. 3, access from the client terminal 30 to the business server 20A has been permitted once, and session information regarding the access-permitted session is stored in the business server 20A and the repository server 10A of the authentication control system 10.

Now, the description will be given for the process performed by the business server 20A to evaluate the session information cached in the business server 20A. Upon reception of a request for content from the client terminal 30 (see (1) in FIG. 3), the business server 20A evaluates the session information cached therein to determine whether or not to perform an authentication process. In this case, the business server 20A determines that the authentication process is not needed, and returns the content to the client terminal 30 (see (2) in FIG. 3). Meanwhile, the business server 20A updates last access time, which is included in the cached session information and represents the time of the latest access, in response to reception of the request for content.

The detailed configuration of the authentication control system 10 will now be described using FIG. 4. FIG. 4 is a block diagram illustrating the configuration of the authentication control system 10 according to the first embodiment. As illustrated in FIG. 4, the authentication control system 10 includes the repository server 10A and the authentication server 10B. The repository server 10A includes a communication control interface (I/F) 11, a control section 12, and a storage section 13. The repository server 10A is coupled to the business servers 20 and the authentication server 10B via a network or the like. The authentication server 10B includes a communication control I/F 14 and a control section 15. Processes performed by the individual sections will be described below.

The communication control I/F 11 controls communication carried out for exchanging various types of information between the business servers 20 and authentication server 10B that are coupled to the repository server 10A. For example, the communication control I/F 11 sends session information to the business servers 20, and also receives an authentication result from the authentication server 10B.

The storage section 13 stores data and programs for use in various processes executed by the control section 12. The storage section 13 includes a session management table 13a and a business-server management table 13b. The session management table 13a stores session information, which is information regarding communication sessions established between, the client terminal 30 and the plurality of business servers 20.

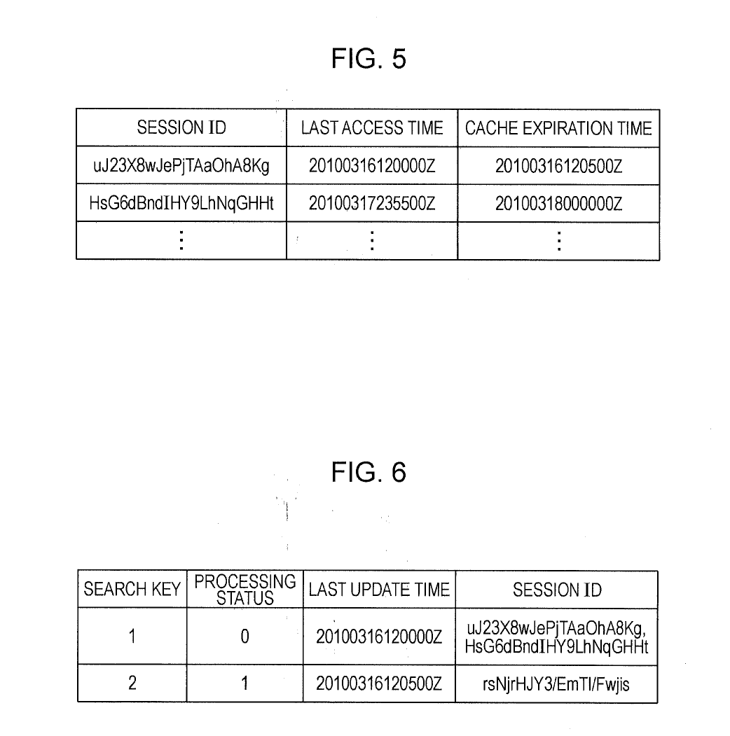

For example, as illustrated in FIG. 5, the session management table 13a stores a “session ID”, “last access time”, and “cache expiration time” that serve as session information. Here, the session ID indicates an ID that uniquely identifies a session. The last access time indicates the time of the last access made by the client terminal 30 to the business servers 20. The cache expiration time indicates the expiration time of the validity of the session.

The business-server management table 13b stores information on the plurality of business servers 20. For example, as illustrated in FIG. 6, the business-server management table 13b stores a “search key”, a “processing status”, “last update time”, and a “session ID”. Here, the search key indicates an ID for identifying the individual business servers 20. The processing status is a flag for use in determining whether or not an update process is underway for the business server 20. The last update time indicates the time of the last update process performed for the business server 20. The session ID indicates an ID of a session established by the client terminal 30 that has accessed the business server 20.

The control section 12 includes an internal memory for storing programs that define procedures of various processes and data to be used in the various processes, and executes the various processes by using the programs and the data. The control section 12 includes a session-information storing unit 12a, a session-information sending unit 12b, a session-information updating unit 12c, a synchronization requesting unit 12d, and a deletion requesting unit 12e.

When the authentication server 10B permits communication between the business server 20 and the client terminal 30 as a result of authentication, the session-information storing unit 12a stores, in the session management table 13a, session information, which is information regarding a communication session established between the business server 20 and the client terminal 30.

When the authentication server 10B permits communication between the business server 20 and the client terminal 30 as a result of authentication, the session-information sending unit 12b sends session information to the business server 20 in response to an evaluation request to evaluate the session information sent from the business server 20.

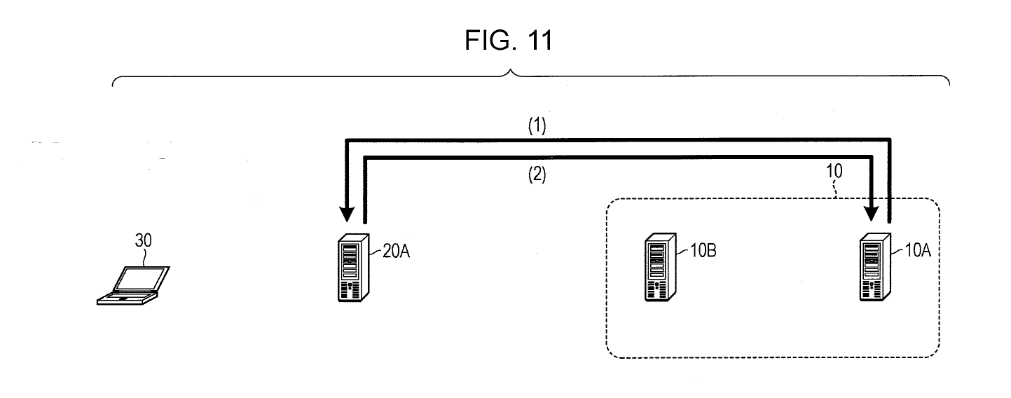

The synchronization requesting unit 12d periodically sends a synchronization request to the individual business servers 20 so that the session information stored in the session management table 13a and the session information stored by the plurality of business servers 20 are updated to the latest information. Details about the synchronization process will be described later using FIG. 11 and so forth.

When the latest session information is received from the business servers 2Q as a response to the synchronization request that has been sent by the synchronization requesting unit 12d, the session-information updating unit 12c updates the corresponding session information stored in the session management table 13a to the received latest session information.

Upon reception of a sign-off request for requesting to terminate the communication, the deletion requesting unit 12e sends a request to delete the session information to the individual business servers 20. Details about the sign-off process will be described later using FIG. 15.

The configuration of the authentication server 10B will now be described. The communication control I/F 14 of the authentication server 10B controls communication carried out for exchanging various types of information between the client terminal 30 and the repository server 10A that are coupled the authentication server 10B. For example, the communication control I/F 14 receives an authentication request from the client terminal 30, and also sends an authentication result to the repository server 10A.

The control section 15 includes an internal memory for storing programs that define procedures of various processes and data to be used in the various processes, and executes the various processes by using the programs and the data. The control section 15 includes an authentication unit 15a. When an authentication request is received from the client terminal 30 that has made a communication request to the business server 20, the authentication unit 15a performs authentication to determine whether or not to permit the communication between the client terminal 30 and the business server 20.

The detailed configuration of the business server 20 will now be described using FIG. 7. FIG. 7 is a block diagram illustrating the configuration of the business server 20 according to the first embodiment. As illustrated in FIG. 7, the business server 20 includes a communication control I/F 21, a control section 22, and a storage section 23. The business server 20 is coupled to the authentication control system 10 and the client terminal 30 via a network or the like. Processes performed by the individual sections will be described below.

The communication control I/F 21 controls communication carried out for exchanging various types of information between the authentication control system 10 and the client terminal 30 that are coupled to the business server 20. For example, the communication control I/F 21 receives session information and a synchronization request to synchronize the session information from the authentication control system 10. The communication control I/F 21 also receives a request for content from the client terminal 30, and sends the content to the client terminal 30.

The storage section 23 stores data and programs for use in various processes executed by the control section 22, and includes a session management table 23a. The session management table 23a stores session information, which is information regarding a communication session established between the business server 20 and the client terminal 30.

For example, as illustrated in FIG. 8, the session management table 23a stores a “session ID”, “last access time”, and “cache expiration time” that serve as session information. Here, the session ID indicates an ID that uniquely identifies a session. The last access time indicates the time of the last access made by the client terminal 30 to the business server 20. The cache expiration time indicates the expiration time of the validity of the session.

The control section 22 includes an internal memory for storing programs that define procedures of various processes and data to be used in the various processes, and executes the various processes by using the programs and the data. The control section 22 includes a session-information storing unit 22a, a session-information updating unit 22b, and a session-information deleting unit 22c.

Upon reception of session information sent from the repository server 10A, the session-information storing unit 22a caches the session information in the session management table 23a. The session-information storing unit 22a updates the content of the session management table 23a when the business server 20 is accessed by the client terminal 30.

Upon reception of a synchronization request from the repository server 10A, the session-information updating unit 22b compares session information contained in the synchronization request with session information stored in the session management table 23a. If the session-information updating unit 22b determines that the session information contained in the synchronization request is the latest session information, the session-information updating unit 22b updates the session information stored in the session management table 23a to the session information contained in the synchronization request.

Upon reception of a request to delete session information from the repository server 10A, the session-information deleting unit 22c deletes the session information stored in the session management table 23a. Details about the sign-off process will be described later using FIG. 15.

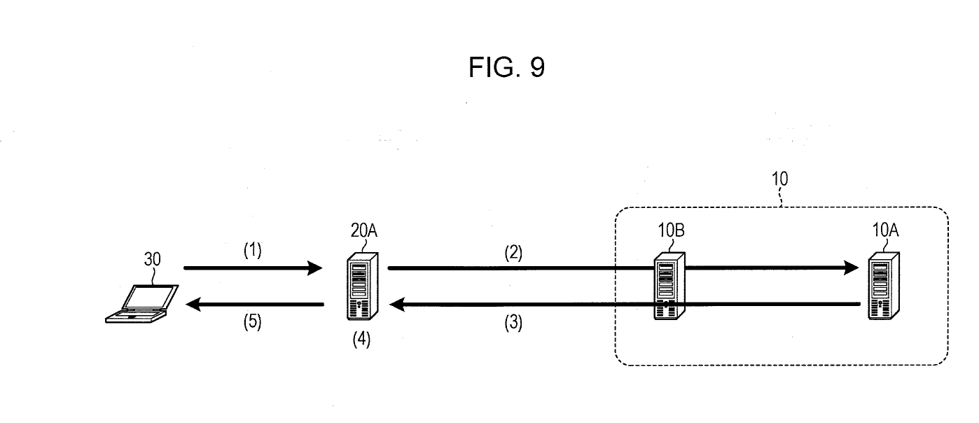

Now, the description will be given using FIG. 9 for a process that is performed when the client terminal 30 makes a request for content in the case where session information is not cached in the business server 20. FIG. 9 is a diagram illustrating the process that is performed when the client terminal 30 makes a request for content in the case where session information is not cached in the business server 20. In FIG. 9, the authentication control system 10 has already performed an authentication process and has already permitted the client terminal 30 to access the business server 20. For example, when the client terminal 30 sends a request to the business server 20A for the first time, session information is not cached in the business server 20A. Accordingly, the business server 20A sends an evaluation request to evaluate session information to the authentication control system 10.

For example, as illustrated in FIG. 9, upon reception of a request for content (see (1) in FIG. 9), the business server 20A sends an evaluation request to evaluate session information to the authentication control system 10 because session information is not cached therein (see (2) in FIG. 9). The repository server 10A then sends a response containing the session information in response to the evaluation request to evaluate the session information (see (3) in FIG. 9). It is assumed here that communication between the business server 20A and the client terminal 30 is permitted as a result of the evaluation.

The business server 20A receives the response, extracts the session information contained in the response, and caches the session information in the session management table 23a (see (4) in FIG. 9) as long as the session management table 23a is not full. The session information cached in the business server 20A is valid for an idle monitoring period, which is a time period during which whether or not communication is performed from the client terminal 30 to the business server 20A is monitored. If no request for content is sent from the client terminal 30 to the business server 20A during the idle monitoring period, authentication is automatically invalidated. The business server 20A uses the idle monitoring period as a time period, during which the business server 20A monitors whether or not the cache expiration time set for the session information cached in the business server 20A has elapsed. Since the communication from the client terminal 30 is permitted in the authentication result, the business server 20A sends the content to the client terminal 30 (see (5) in FIG. 9).

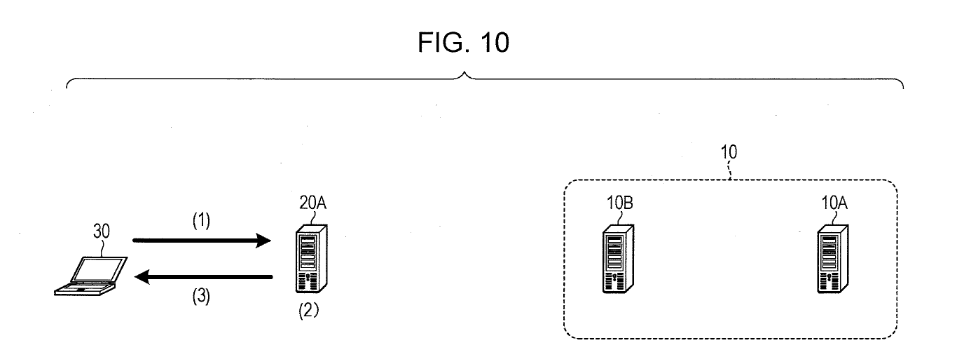

The description will now be given using FIG. 10 for a process that is performed when the client terminal 30 makes a request for content in the case where session information is cached in the business server 20. FIG. 10 is a diagram illustrating the process that is performed when the client terminal 30 makes a request for content in the case where session information is cached in the business server 20A.

For example, in response to a request for content received after the session information has been cached in the business server 20A, the business server 20A evaluates a state of a corresponding session using the cached session information. The business server 20A returns a response based on a result of the evaluation. As illustrated in FIG. 10, when the business server 20A receives a request for content from the client terminal 30 (see (1) in FIG. 10), the business server 20A determines whether or not session information for the client terminal 30 is cached. When the business server 20A determines that the session information for the client terminal 30 is cached, the business server 20A updates the last access time (see (2) in FIG. 10), and then returns the content to the client terminal 30 (see (3) in FIG. 10).

The response performance improves by using the foregoing configuration compared with the case where the business server 20A requests the authentication control system 10 to evaluate session information every time the client terminal 30 attempts to access the business server 20A. In the foregoing process, the business server 20A also updates the cache expiration time and the last access time which are contained in the session information cached in the business server 20A. Accordingly, the real-time property of the session information cached in the business server 20A may be maintained.

The synchronization process of synchronizing session information will be described next. FIG. 11 is a diagram for describing the synchronization process of synchronizing session information. After the client terminal 30 has accessed the business server 20, the repository server 10A of the authentication control system 10 sends a request to synchronize session information (hereinafter, referred to as a “synchronization request”) to the business server 20A (see (1) in FIG. 11). The synchronization request is periodically sent to the business server 20A at time intervals (hereinafter, referred to as “synchronization-request sending intervals”) shorter than the idle monitoring period. The synchronization request contains session information of a session established for a user who is accessing the business server 20A to which the synchronization request is to be sent.

The business server 20A that has received the synchronization request compares the last access time of the cached session information with the last access time of the session information contained in the synchronization request, and performs the following processing in accordance with a result of the comparison. The business server 20A then returns a response to the repository server 10A (see (2) in FIG. 11).

For example, when the last access timeof the cached session time is later than the last access time contained in the synchronization request as a result of the comparison, the business server 20A includes the cached session information in a response, and sends the response to the repository server 10A. In this case, the business server 20A does not update the cache expiration time and the last access time of the session information cached in the business server 20A. The repository server 10A that has received the response updates the last access time and the idle monitoring period stored in the repository server 10A to the last access time and the idle monitoring period contained in the response, respectively.

When the last access time of the cached session information is not later than the last access time contained in the synchronization request as a result of the comparison, the business server 20A updates the cached last access time to the last access time of the session information contained in the synchronization request. In this case, the business server 20A also updates the cache expiration time of the cached session information. Here, the cache expiration time indicates the time at which a session is invalidated if the idle monitoring period elapses from the last access time contained in the synchronization request.

The repository server 10A that has received the response from the business server 20A updates only items of the session information contained in the response. Only items of the session information cached in the business server 20A that are determined to be the latest information are contained in the response. That is, the items of the session information to be updated are the last access time and the idle monitoring period. As a result the foregoing process, the last access time stored by the business server 20A and the last access time stored by the repository server 10A indicate the same value and, thus, the real-time property of the session information may be maintained. When session information subjected to synchronization is not cached in the business server 20A to reduce the load of the business server 20A and the repository server 10A, the repository server 10A does not send the synchronization request to the business server 20A.

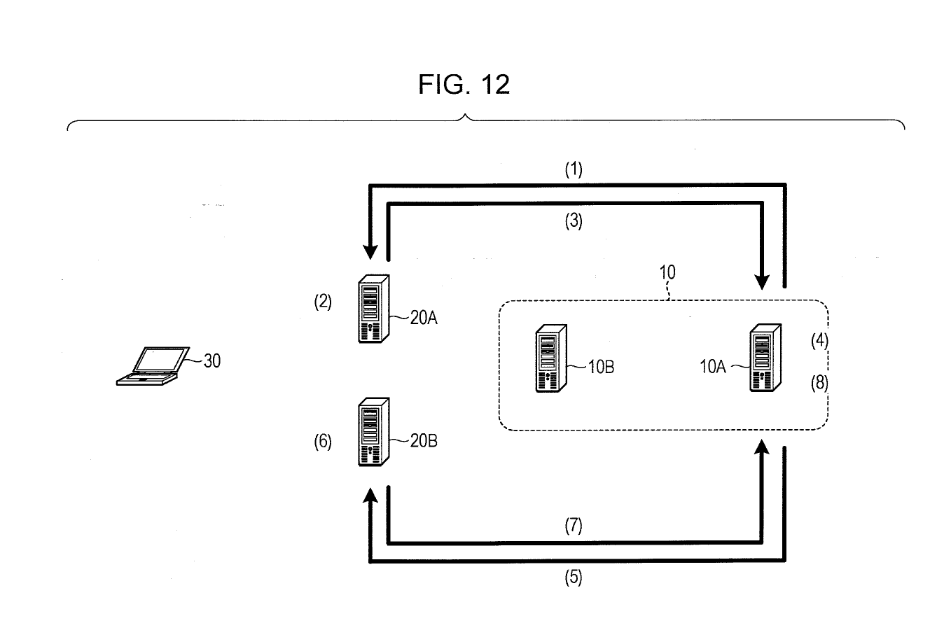

A process of synchronizing session information between a plurality of business servers will now be described using FIG. 12. FIG. 12 is a diagram describing the process of synchronizing session information between a plurality of business servers. As illustrated in FIG. 12, when a plurality of business servers exist, the process described in FIG. 11 is performed on all business servers that have received a request from the client terminal 30.

For example, as illustrated in FIG. 12, the repository server 10A sends a synchronization request to synchronize session information to the business server 20A (see (1) in FIG. 12). When the cached session information is older than the session information contained in the synchronization request, the business server 20A updates the cached session information (see (2) in FIG. 12). In contrast, when the cached session information is newer than the session information contained in the synchronization request, the business server 20A sends the cached session information to the repository server 10A (see (3) in FIG. 12). The repository server 10A then updates the session information managed in the repository server 10A based on the session information received from the business server 20A (see (4) in FIG. 12).

Subsequently, the repository server 10A sends a synchronization request to synchronize session information to the business server 20B (see (5) in FIG. 12). When the cached session information is older than the session information contained in the synchronization request, the business server 20B updates the cached session information (see (6) in FIG. 12). In contrast, when the cached session information is newer than the session information contained in the synchronization request, the business server 20B sends the cached session information to the repository server 10A (see (7) in FIG. 12). The repository server 10A then updates the session information managed in the repository server 10A based on the session information received from the business server 20B (see (8) in FIG. 12).

As described above, the repository server 10A updates the session information using the latest information among from the pieces of information contained in the responses sent from the plurality of business servers 20A and 20B. With this configuration, the real-time property of the session information may be maintained even when the plurality of business servers 20A and 20B exist.

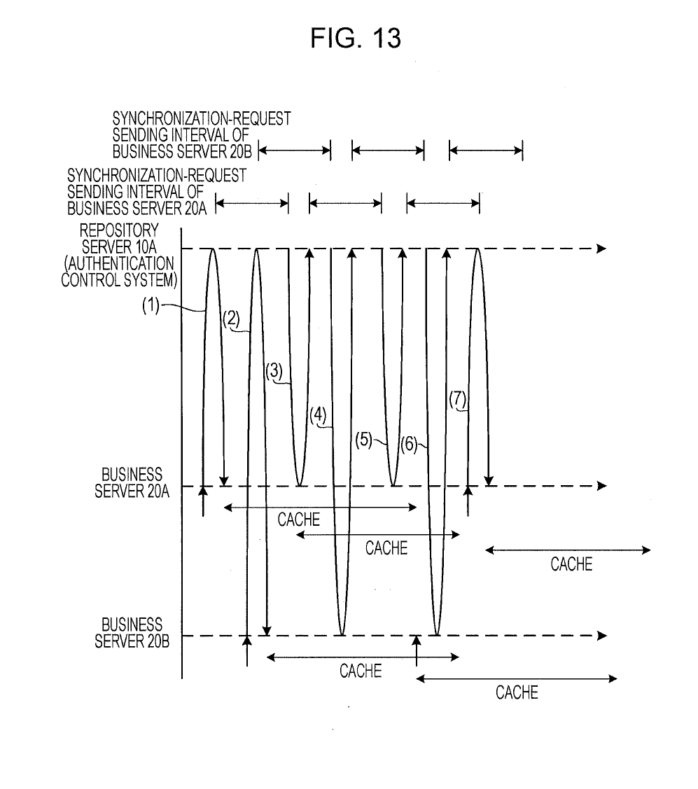

The flow of the synchronization process will now be described using FIG. 13. FIG. 13 is a timing chart describing the flow of the synchronization process. In FIG. 13, the authentication control system 10 has already performed an authentication process on the client terminal 30 and the client terminal 30 has been permitted to access the business servers 20. As illustrated in FIG. 13, the business server 20A that has received an access request from the client terminal 30 sends an evaluation request to evaluate session information to the repository server 10A (authentication control system 10). The business server 20A then receives a response from the repository server 10A and caches session information contained in the response (see (1) in FIG. 13). Here, it is assumed that the cached session information is valid during the idle monitoring period from the last access time (the valid period of the session information is denoted as “cache” in FIG. 13). The repository server 10A also sends a synchronization request at predetermined intervals (denoted as “synchronization-request sending intervals” in FIG. 13) from the first authentication request sent from the business server 20A.

The business server 20B that has received an access request from the same client terminal 30 sends an evaluation request to evaluate session information to the repository server 10A (authentication control system 10). The business server 20B then receives a response from the repository server 10A. Just like the business server 20A, the business server 20B caches the session information contained in the response (see (2) in FIG. 13). The repository server 10A updates the last access time of the session information managed in the repository server 10A because the business server 20B is accessed by the client terminal 30.

After the synchronization-request sending interval set for the business server 20A has elapsed, synchronization requesting unit 12d of the repository server 10A notifies the last access time to the business server 20A by sending the synchronization request. In other words, the business server 20A obtains the session information including the last access time of the business server 20B from the business server 20B via the repository server 10A with the synchronization request. The last access time of the session information managed by the repository server 10A is later than the last access time cached in the business server 20A. Accordingly, the business server 20A updates the last access time and the cache expiration time so that the storage section 23 stores the session information until the expiration time elapses from the updated last access time (see (3) in FIG. 13).

After the synchronization-request sending interval set for the business server 20B has elapsed, the repository server 10A sends the synchronization request to the business server 20B. The business server 20B does not update the session information because the last access time of the session information managed by the repository server 10A is the same as the last access time of the cached session information (see (4) in FIG. 13).

After the synchronization-request sending interval set for the business server 20A has elapsed, the repository server 10A similarly sends the synchronization request to the business server 20A (see (5) in FIG. 13). It is assumed that the business server 20B is accessed by the client terminal 30 thereafter and the session information cached in the business server 20B is updated. After the synchronization-request sending interval set for the business server 20B has elapsed, the repository server 10A sends the synchronization request to the business server 20B. Since the last access time of the session information cached in the business server 20B is later than the last access time of the session information contained in the synchronization request, the business server 20B sends a response containing the cached session information to the repository server 10A. The repository server 10A then updates the managed session information based on the session information contained in the response (see (6) in FIG. 13).

When the business server 20A is accessed by the client terminal 30 after the cache expiration time has elapsed, the business server 20A requests the repository server 10A to evaluate a session as in the first access because the cached session information is invalidated. The session information managed by the repository server 10A is updated to the session information notified by the business server 20B. Accordingly, the repository server 10A considers that the request is made during the idle monitoring period and may send a response for permitting the access to the business server 20B without performing authentication (see (7) in FIG. 13).

As described above, the synchronization request to synchronize session information is periodically sent to the business servers 20A and 20B from the authentication control system 10, whereby content of the session information of the authentication control system 10 and the business servers 20A and 20B are updated to the latest information. In contrast, when the synchronization process of synchronizing session information is not performed, the business server that has received a request for content from a client terminal may correctly update the last access time but the other business servers may fail to update the last access time. For this reason, the integrity of the session information cached in the business servers is not maintained. As a result, the real-time property of the session information may no longer be maintained in the entire single sign-on system.

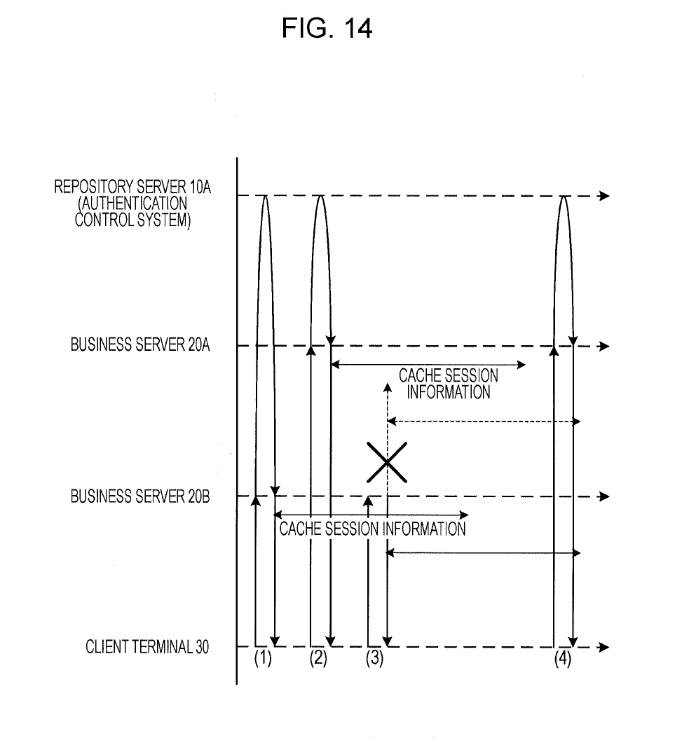

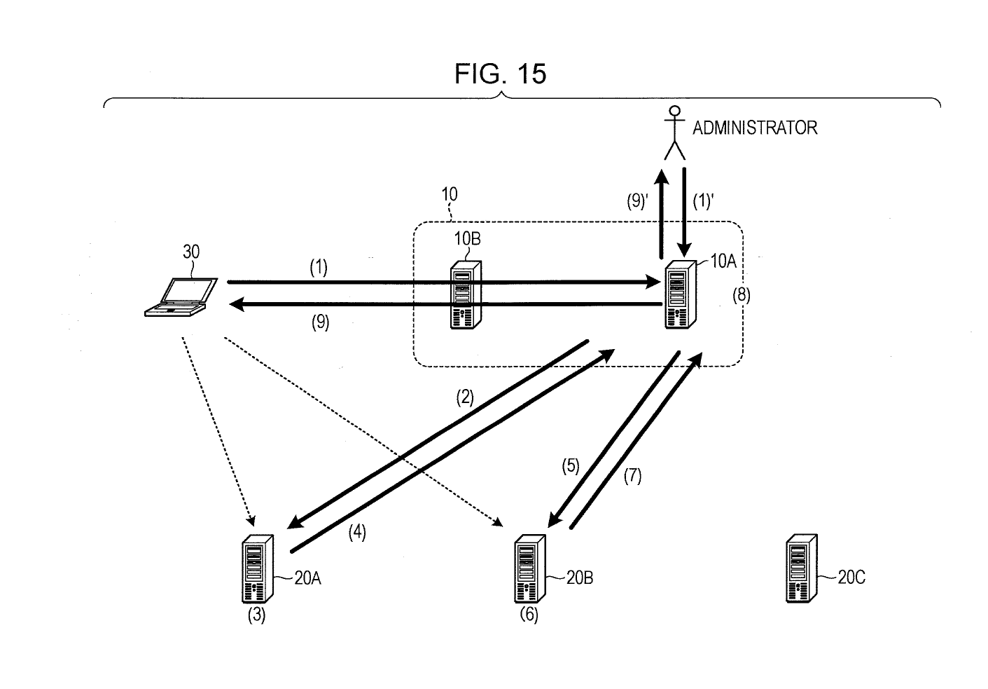

The case where the synchronization process of synchronizing session information is not performed will now be described concretely using FIG. 14. In an example illustrated in FIG. 14, the business servers 20A and 20B exist, and each of the business servers 20A and 20B caches session information. Furthermore, in the example illustrated in FIG. 14, the authentication control system 10 has already performed an authentication process on the client terminal 30 and the client terminal 30 has been permitted to access the business servers 20A and 20B. As illustrated in FIG. 14, when the business server 20B is accessed by the client terminal 30 for the first time, the business server 20B sends an evaluation request to evaluate session information to the authentication control system 10. The business server 20B then receives a response from the authentication control system 10, and caches session information contained the response (see (1) in FIG. 14).

When the business server 20A is accessed by the client terminal 30 for the first time, the business server 20A similarly sends an evaluation request to evaluate session information to the authentication control system 10. The business server 20A then receives a response from the authentication control system 10, and caches session information contained in the response (see (2) in FIG. 14).

When the business server 20B is accessed by the client terminal 30 thereafter, the business server 20B evaluates the session and updates the cached session information because the cached session information is valid. Here, the business server 20B updates the last access time of the session information, thereby updating the session expiration time (see (3) in FIG. 14).

In the example illustrated in FIG. 14, the synchronization process of synchronizing session information is not performed. Thus, the business server 20B that has received the request from the client terminal 30 does not notify the business server 20A of reception of the request. For this reason, the business server 20B may successfully update the last access time of the cached session information but the business server 20A may fail to update the, last access time. As a result, the validity of the session information expires in the business server 20A earlier than in the business server 20B.

When the business server 20A receives an access request from the client terminal 30 after the validity of the session information has expired, the business server 20A sends an evaluation request to evaluate session information to the authentication control system 10. Since the last access time of the session information stored by the authentication control system 10 is not also updated, authentication may occur at a timing when authentication is supposed to be unnecessary (see (4) in FIG. 14). As described above, when the synchronization process of synchronizing session information is not performed, the real-time property of the session information may no longer be maintained in the entire single sign-on system. In contrast, in the session management system 1 according to the first embodiment, a synchronization request to synchronize session information is periodically sent to the business servers 20A and 20B from the authentication control system 10, and the content of the session information stored in the authentication control system 10 and the business servers 20A and 20B is updated to the latest information. Accordingly, the real-time property of the session information may be maintained in the entire single sign-on system.

The sign-off process will be described next using FIG. 15. FIG. 15 is a diagram describing the sign-off process. As illustrated in FIG. 15, when the client terminal 30 makes a sign-off request or when an administrator makes a forced sign-off request (see (1) or (1)′ in FIG. 15), the repository server 10A sends a deletion request to delete cached session information to the business server 20A (see (2) in FIG. 15).

Upon reception of the deletion request, the business server 20A deletes the cached session information (see (3) in FIG. 15), and sends a result of the deletion to the repository server 10A (see (4) in FIG. 15). The repository server 10A similarly sends a deletion request to delete cached session information to the business server 20B (see (5) in FIG. 15). Upon reception of the deletion request, the business server 20B deletes the cached session information (see (6) in FIG. 15), and sends a result of the deletion to the repository server 10A (see (7) in FIG. 15). The repository server 10A then deletes the session information managed in the repository server 10A (see (8) in FIG. 15), and sends a result indicating completion of sign-off to the client terminal 30 or the administrator who has requested for forced sign-off (see (9) or (9)′ in FIG. 15). Meanwhile, the deletion request is not sent to a business server 20C in which session information subjected to sign-off is not cached.

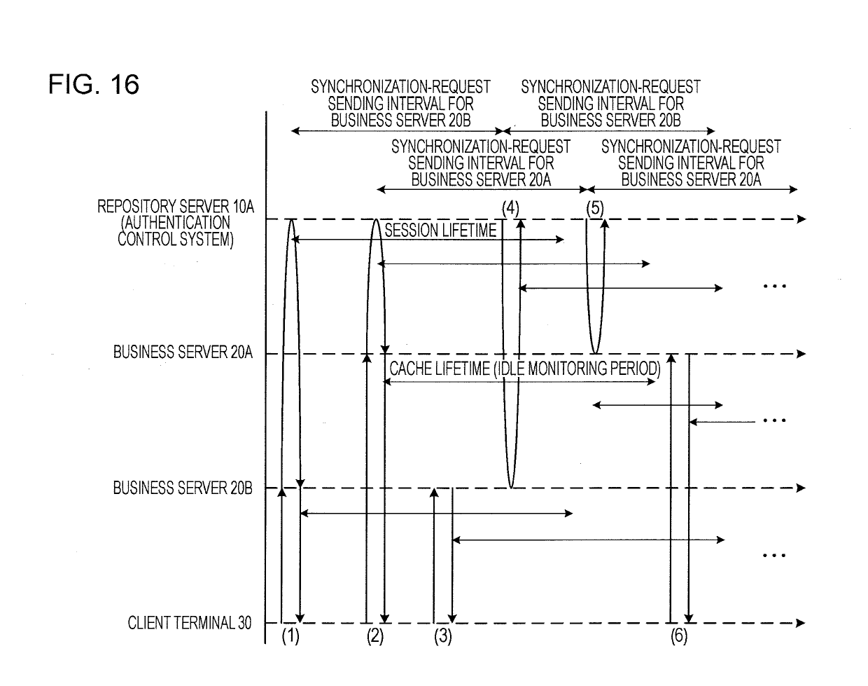

The description will now be given using FIG. 16 for the process of updating the session management table in which sessions of the entire session management systems 1 are managed. FIG. 16 is a timing chart describing the flow of the process of managing session information performed by the individual servers. In FIG. 16, the authentication control system 10 has already performed an authentication process on the client terminal 30, and the client terminal 30 has been permitted to access the business servers 20. As illustrated in FIG. 16, the business server 20B that has received an access request from the client terminal 30 sends an evaluation request to evaluate session information to the repository server 10A (authentication control system 10). The business server 20B then receives a response containing session information from the repository server 10A, and caches the session information (see (1) in FIG. 16). In this case, the repository server 10A updates the session management table 13a and the business-server management table 13b, and sets a synchronization-request sending interval for the business server 20B.

Thereafter, the business server 20A that has received an access request from the client terminal 30 sends an evaluation request to evaluate session information to the repository server 10A (authentication control system 10). The business server 20A then receives a response containing the session information from the repository server 10A, and caches the session information (see (2) in FIG. 16). In this case, the repository server 10A updates the session management table 13a and the business-server management table 13b, and sets a synchronization-request sending interval for the business server 20A.

Then, the business server 20B receives an access request from the client terminal 30, and updates the session information cached in the business server 20B (see (3) in FIG. 16). After the synchronization-request sending interval set for the business server 20B has elapsed, the repository server 10A sends a synchronization request to the business server 20B. In this case, the business server 20B sends a response containing the cached session information to the repository server 10A because the last access time of the cached session information is later than the last access time of the session information contained in the synchronization request. The repository server 10A then updates the session information managed in the repository server 10A based on the session information contained in the response (see (4) in FIG. 16).

Subsequently, after the synchronization-request sending interval set for the business server 20A has elapsed, the repository server 10A sends a synchronization request to the business server 20A. Since the last access time of the session information managed in the repository server 10A is later than the last access time of the cached session information, the business server 20A updates the last access time and the cache expiration time (see (5) in FIG. 16).

The business server 20A then receives an access request from the client terminal 30. At this time, an evaluation request to evaluate session information does not occur since the cache expiration time cached in the business server 20A is updated to the cached expiration time contained in the synchronization request. The business server 20A updates the cached session information (see (6) in FIG. 16).

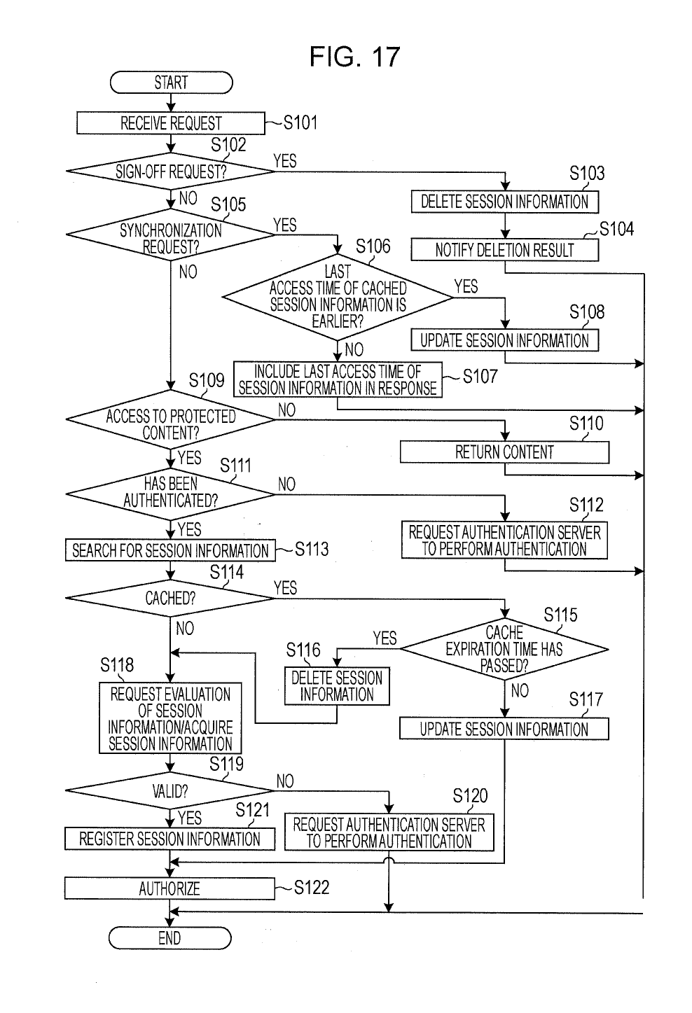

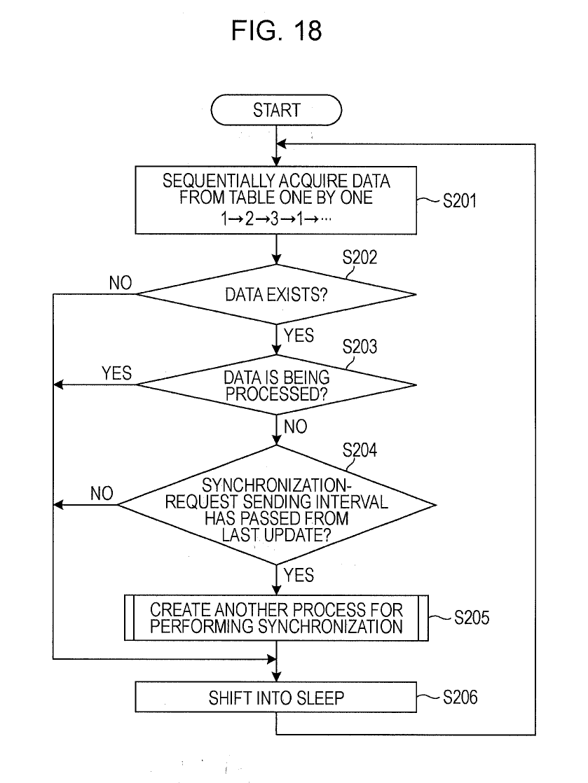

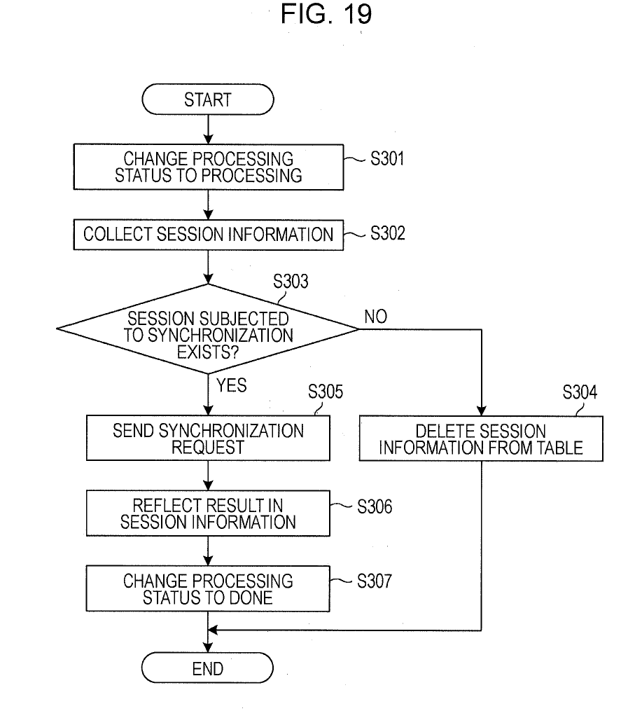

The process performed by the session management system 1 according to the first embodiment will now be described using FIGS. 17 to 19. FIG. 17 is a flowchart illustrating operations of the process performed by the business server 20 according to the first embodiment. FIG. 18 is a flowchart illustrating the monitoring operation of the synchronization process performed by the repository server 10A according to the first embodiment. FIG. 19 is a flowchart illustrating operations of the synchronization process performed by the repository server 10A according to the first embodiment.

As illustrated in FIG. 17, upon reception of a request (S101), the business server 20 determines whether or not the received request is a sign-off request (S102). When the business server 20 determines that the received request is the sign-off request as a result of the determination, the business server 20 deletes session information (S103) and notifies the repository server 10A of a result of the deletion (S104).

When the business server 20 determines that the received request is not the sign-off request, the business server 20 determines whether or not the received request is a synchronization request (S105). When the business server 20 determines that the received request is the synchronization request as a result of the determination, the business server 20 determines whether or not the last access time of the cached session information is earlier than the last access time of the session information contained in the synchronization request (S106). When the business server 20 determines that the last access time of the cached session information is earlier than the last access time of the session information contained in the synchronization request as a result of the determination, the business server 20 updates the cached session information (S108). When the business server 20 determines that the last access time of the cached session information is not earlier than the last access time of the session information contained in the synchronization request, the business server 20 sends a response containing the last access time of the cached session information to the repository server 10A (S107).

When the business server 20 determines that the received request is not the synchronization request, the business server 20 determines whether or not the received request is a request to access protected content (S109). When the business server 20 determines that the received request is the request to access unprotected content as a result of the determination, the business server 20 returns the content to the client terminal 30 because an authentication process is not needed (S110). When the business server 20 determines that the received request is the request to access protected content, the business server 20 determines whether or not the client terminal 30 has already been authenticated (S111). When the business server 20 determines that the client terminal 30 has not been authenticated as a result of the determination, the business server 20 requests the authentication server 1013 to perform authentication (S112).

When the business server 20 determines that the client terminal 30 has been authenticated, the business server 20 searches for corresponding session information (S113) and determines whether or not the session information is stored in the session management table 23a (S114). When the business server 20 determines that the session information is stored in the session management table 23a as a result of the determination, the business server 20 determines whether or not the cache expiration time has elapsed (S115). When the business server 20 determines that the cache expiration time has not elapsed, the business server 20 updates the session information (S117) and returns the content to the client terminal 30 (S122).

When the business server 20 determines that the cache expiration time has elapsed, the business server 20 deletes the session information (S116). When the business server 20 determines that the session information is not stored in the session management table 23a, the business server 20 requests the authentication control system 10 to evaluate session information and obtains the session information (S118). The business server 20 then determines whether or not the session information is valid (S119). When the session information is valid, the business server 20 registers the session information (S121) and returns the content to the client terminal 30 (S122). When the business server 20 determines that the session information is invalid, the business server 20 requests the authentication server 10B to perform authentication (S120).

The process performed by the repository server 10A will now be described using FIG. 18. As illustrated in FIG. 18, the repository server 10A obtains one piece of data from the business-server management table 13b (S201), and determines whether or not obtainable data exists (S202). When obtainable data exists, the repository server 10A determines whether or not the data is being processed (S203). When the data is not being processed, the repository server 10A determines whether or not the synchronization-request sending interval has elapsed from the last update (S204). When the repository server 10A determines that the synchronization-request sending interval has elapsed from the last update as a result of the determination, the repository server 10A generates another independent process that performs the synchronization process which will be described in detail later using FIG. 19 (S205). The repository server 10A shifts into a sleep state in which operations of the repository server 10A temporarily stop (S206), and then the process returns to S201. When obtainable data does not exist in S202, when the data is being processed in S203, and when the synchronization-request sending interval has not elapsed in S204, the repository server 10A shifts into the sleep state (S206) and then the process returns to S201.

The flow of the synchronization process performed by the repository server 10A will now be described using FIG. 19. As illustrated in FIG. 19, the repository server 10A changes the processing status contained in the business-server management table 13b to “processing” (S301), and collects session information (S302). The repository server 10A then determines whether or not the business server 20 has session information subjected to synchronization (S303). When the business server 20 does not have the session information subjected to synchronization, the repository server 10A deletes the information from the business-server management table 13b (S304).

When the business server 20 has the session information subjected to synchronization, the repository server 10A sends a synchronization request to the individual business servers 20 (S305) and reflects the result in the session information (S306). The repository server 10A changes the processing status contained in the business-server management table 13b to “done” (S307) and terminates the process.

As described above, when the authentication control system 10 receives an authentication request from the client terminal 30 that has made a communication request to the business server 20, the authentication control system 10 performs authentication and determines whether or not to permit communication of the client terminal 30. When the authentication control system 10 permits the communication of the client terminal 30, the authentication control system 10 stores, in the session management table 13a, session information which is information regarding a communication session established between the client terminal 30 and the business server 20. When the authentication control system 10 receives an evaluation request to evaluate session information from the business server 20 thereafter, the authentication control system 10 sends the session information to the business server 20. The authentication control system 10 further requests the plurality of business servers 20 to perform synchronization so that the session information stored in the authentication control system 10 and the session information stored in the plurality of business servers 20 are updated to the latest information. As a result, even when the plurality of business servers 20A and 20B exist, the real-time property of the session information may be maintained and the performance of processing a request of the client terminal 30 may be improved in the entire session management system 1.

In addition, according to the first embodiment, the authentication control system 10 sends, to the business servers 20, a synchronization request to request the business servers 20 to synchronize the session information stored in the session management table 13a and the session information stored in the business servers 20 at intervals shorter than the idle monitoring period, during which whether or not communication from the client terminal 30 to the corresponding business servers 20 is performed is monitored. Accordingly, the authentication control system 10 may perform synchronization so that the session information is updated to the latest information before the session information is invalidated as the idle monitoring period has elapsed. Thus, the authentication control system 10 may appropriately synchronize the session information between the business servers 20A and 20B and may allow the latest synchronized information to be stored in the business servers 20A and 20B. As a result, the real-time property of the session information may be maintained and the performance of processing a request of the client terminal 30 may be improved in the entire session management system 1.

Furthermore, according to the first embodiment, when the authentication control system 10 receives the latest session information from the business server 20 as a response to a synchronization request that has been sent, the authentication control system 10 updates the session information stored in the session management table 13a based on the latest session information. With this configuration, the authentication control system 10 may appropriately synchronize the session information between the business servers 20A and 20B and may allow the latest synchronized information to be stored in the business servers 20A and 20B. As a result, the real-time property of the session information may be maintained and the performance of processing a request of the client terminal 30 may be improved in the entire session management system 1.

Moreover, according to the first embodiment, when the authentication control system 10 receives a request to terminate communication, the authentication control system 10 sends a request to delete session information to the business servers 20. Accordingly, the authentication control system 10 may appropriately delete the session information. According to the embodiment, an increase in the number of times communication is performed for synchronization of session information may be suppressed even when the number of times a client terminal accesses business servers increases.

Meanwhile, each component of the repository server 10A and the authentication server 10B illustrated in FIG. 4 and each component of the business server 20 illustrated in FIG. 7 are based on a functional concept. Accordingly, each component illustrated in FIGS. 4 and 7 does not have to be configured in an illustrated manner. That is, specific embodiments regarding distribution or integration of components are not limited by the illustrated ones and all or some of the components may be functionally or physically distributed or integrated in given units in accordance with various load and usage states. For example, the function of the storage section 13 included in the repository server 10A illustrated in FIG. 4 may be included in another server.

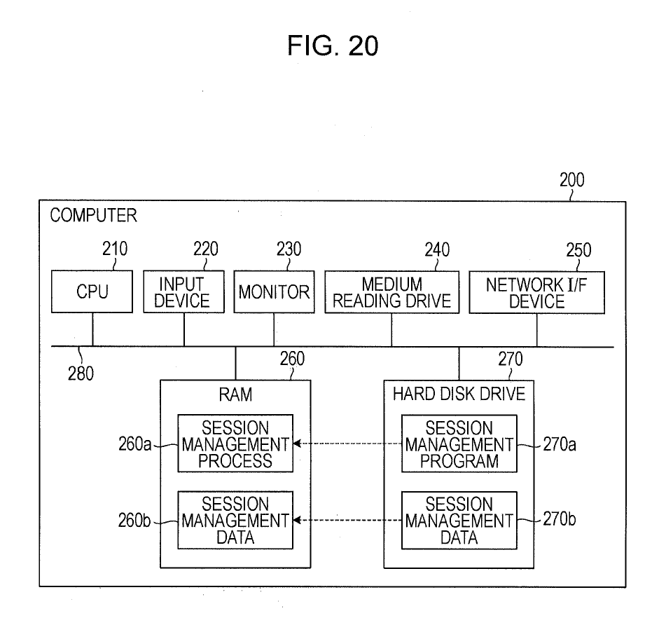

Additionally, the functions of the apparatuses illustrated in FIGS. 4 and 7 may be implemented as hardware or software. For example, a hardware configuration of a computer that constitutes the repository server 10A illustrated in FIG. 4 is illustrated in FIG. 20. And for example, a hardware configuration of a computer that constitutes the business server 20 illustrated in FIG. 7 is illustrated in FIG. 20.

As illustrated in FIG. 20, a computer 200 includes a central processing unit (CPU) 210 that executes various kinds of computing processing, an input device 220 that receives data input from a user, and a monitor 230. The CPU 210 is an example of a processor which reads out and executes a session management program from a hard disk drive 270. The processor is a hardware to carry out operations based on at least one program (such as the session management program) and control other hardware, such as the CPU 210, a GPU (Graphics Processing Unit), FPU (Floating point number Processing Unit) and DSP (Digital signal Processor). The computer 200 also includes a medium reading drive 240 that reads programs or the like from storage media, and a network interface device 250 that exchanges data with other computers via a network. The computer 200 further includes a random access memory (RAM) 260 that temporarily stores various types of information, and a hard disk drive 270. The CPU 210, the input device 220, the monitor 230, the medium reading drive 240, the network interface device 250, the RAM 260, and the hard disk drive 270 are coupled to a bus 280.

The hard disk drive 270 stores the session management program 270a that has the same functions as the session-information storing unit 12a, the session-information sending unit 12b, the session-information updating unit 12c, the synchronization requesting unit 12d, and the deletion requesting unit 12e illustrated in FIG. 4. The hard disk drive 270 also stores session management data 270b that corresponds to the session management table 13a and the business-server management table 13b illustrated in FIG. 4. The RAM 260 is a readable and writable media, such as a SRAM (Static RAM), DRAM (Dynamic RAM), and a flush memory. Session management data 260b may be stored in the RAM 260, and the CPU 210 may read out the session management data 260b stored in the RAM 260 according to circumstances.

The CPU 210 reads out the session management program 270a from the hard disk drive 270 and loads the session management program 270a into the RAM 260, whereby the session management program 270a functions as a session management process 260a. The session management process 260a loads the session management data 270b into the RAM 260, and executes various session management processes.

The session management program 270a does not have to be stored in the hard disk drive 270. For example, the session management program 270a stored on a storage medium, such as a CD-ROM, may be read out and executed by the computer 200. The session management program 270a may be stored in a device coupled via a public line, the Internet, a local area network (LAN), a wide area network (WAN), or the like, and the computer 200 may read out and execute the session management program 270a therefrom.

The computer 200 illustrated in FIG. 20 may constitutes the repository server 10A illustrated in FIG. 4. In such case, the CPU 210 has a function of the control section 12 illustrated in FIG. 4. Processing executed by the session-information storing unit 12a, session-information sending unit 12b, session-information updating unit 12c, synchronization requesting unit 12d, and deletion requesting unit 12e may be executed by the CPU 210. The RAM 260 has a function of the storage section 13 illustrated in FIG. 4. The RAM 260 stores the session management table 13a and business-server management table 13b. And the network interface device 250 has a function of the communication control I/F 11 illustrated in FIG. 4.

The computer 200 illustrated in FIG. 20 may constitutes the authentication server 10B illustrated in FIG. 4. In such case, the CPU 210 has a function of the control section 15 illustrated in FIG. 4. Processing executed by the authentication unit 15a may be executed by the CPU 210. And the network interface device 250 has a function of the communication control I/F 14 illustrated in FIG. 4.

The computer 200 illustrated in FIG. 20 may constitutes the business server 20 illustrated in FIG. 7. In such case, The CPU 210 has a function of the control section 22 illustrated in FIG. 7. Processing executed by the session-information storing unit 22a, the session-information updating unit 22b, and session information deleting unit 22c may be executed by the CPU 210. The RAM 260 has a function of the storage section 23 illustrated in FIG. 7. The RAM 260 stores session management table 23a. And the network interface device 250 has a function of the communication control I/F 21 illustrated in FIG. 7.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A server apparatus comprising:
storing means for storing identification information for identifying a session used for first access made to the server apparatus, until a certain length of time elapses from access time of the first access; and
obtaining means for obtaining the time information which indicates access time of an access made to another server apparatus, wherein when the obtaining means obtains time information, which indicates access time of second access made to the another server apparatus after the first access by using the same session as the session used for the first access, until the certain length of time elapses from access time of the first access, the storing means stores the identification information until the certain length of time further elapses from the access time indicated by the obtained time information.

2. The server apparatus according to claim 1, further comprising:
responding means for sending a response to third access, which is made to the server apparatus after the first access by using the same session as the session used for the first access, when the identification information is stored by the storing means.

3. A server apparatus comprising:
a memory; and
a processor to execute a procedure, the procedure including:
storing, in the memory of the server apparatus, identification information for identifying a session used for first access made to the server apparatus, until a certain length of time elapses from access time of the first access;
obtaining the time information which indicates access time of an access made to another server apparatus; and
when time information, which indicates access time of second access made to the another server apparatus after the first access by using the same session as the session used for the first access, is obtained by the obtaining until the certain length of time elapses from access time of the first access, controlling the memory to store the identification information until the certain length of time further elapses from the access time indicated by the obtained time information.

4. The server apparatus according to claim 3, wherein the processor sends a response to third access, which is made to the server apparatus after the first access by using the same session as the session used for the first access, when the identification information is stored in the memory.

5. A session management method comprising:
storing, in a memory of a first apparatus, identification information for identifying a session used for first access made to the first apparatus, until a certain length of time elapses from access time of the first access;
obtaining the time information which indicates access time of an access made to a second apparatus; and
when time information, which indicates access time of second access made to the second apparatus after the first access by using the same session as the session used for the first access, is obtained by the obtaining until the certain length of time elapses from access time of the first access, controlling the memory to store the identification information until the certain length of time further elapses from the access time indicated by the obtained time information, by the first computer.

6. The session management method according to claim 5, further comprising:
sending a response to third access, which is made to the first apparatus after the first access by using the same session as the session used for the first access, when the identification information is stored in the memory.

7. A computer-readable, non-transitory recording medium to store session management program for causing a first apparatus to execute a procedure, the procedure comprising:
storing, in a memory of the first apparatus, identification information for identifying a session used for first access made to the first apparatus, until a certain length of time elapses from access time of the first access;
obtaining the time information which indicates access time of an access made to a second apparatus; and
when time information, which indicates access time of second access made to the second apparatus after the first access by using the same session as the session used for the first access, is obtained by the obtaining until the certain length of time elapses from access time of the, first access, controlling the memory to store the identification information until the certain length of time further elapses from the access time indicated by the obtained time information.

8. The recording medium according to claim 7, wherein the procedure further comprises:
sending a response to third access, which is made to the first apparatus after the first access by using the same session as the session used for the first access, when the identification information is stored in the memory.

9. A session management system comprising:
a first server apparatus; and
a second server apparatus;
wherein the first server apparatus includes:
storing means for storing identification information for identifying a session used for first access made to the server apparatus, until a certain length of time elapses from access time of the first access; and
obtaining means for obtaining the time information which indicates access time of an access made to another server apparatus,
wherein when the obtaining means obtains time information, which indicates access time of second access made to the another server apparatus after the first access by using the same session as the session used for the first access, until the certain length of time elapses from access time of the first access, the storing means stores the identification information until the certain length of time further elapses from the access time indicated by the obtained time information.

10. The session management system according to claim 9, further comprising:
responding means for sending a response to third access, which is made to the server apparatus after the first access by using the same session as the session used for the first access, when the identification information is stored in the storing means.

11. A session management apparatus capable of communicating with a first apparatus and a second apparatus, the first apparatus being configured to store identification information for identifying a session used for first access until a certain length of time elapses from access time of the first access, the session management apparatus comprising:
first obtaining means for obtaining, from the first apparatus, first time information that indicates the access time of the first access;
second obtaining means for obtaining, from the second apparatus, second time information that indicates access time of second access made to the second apparatus after the first access by using the same session as the session used for the first access; and
notifying means for notifying the first apparatus of the second time information before the certain length of time elapses from the access time indicated by the first time information.
